(19) United States
(12) Patent Application Publication
(10) Pub. No.: US 2017/0314458 A1
(43) Pub. Date: Nov. 2, 2017

(54) INTERNAL COMBUSTION ENGINE

(71) Applicant: TOYOTA JIDOSHA KABUSHIKI KAISHA, Toyota-shi (JP)

(72) Inventor: lsao MATSUMOTO, Sunto-gun (JP)

(73) Assignee: TOYOTA JIDOSHA KABUSHIKI KAISHA, Toyota-shi (JP)

(21) Appl. No.: 15/499,940

(22) Filed: Apr. 28, 2017

(30) Foreign Application Priority Data
May 2, 2016 (JP) 2016-092576

(51) Int. Cl. F02B 37/02; F01N 3/02; F01N 3/04; F01N 3/10

(52) U.S. Cl. CPC F02B 37/025; F01N 3/10; F01N 3/0205; F01N 3/04

(57) ABSTRACT

An internal combustion engine includes a twin entry type turbocharger with which a first exhaust passage and a second exhaust passage respectively communicate individually, a space forming section that communicates with the first exhaust passage via a first communication path, and communicates with the second exhaust passage via a second communication path, a communication control valve that opens and closes the first communication path and the second communication path, and a drive mechanism that is connected to a valve body of the communication control valve and drives the valve body to open and close the valve body. The drive mechanism is provided at a side of the space forming section with respect to the valve body in a state where the valve body is closed.

### FIELD

The present disclosure relates to an internal combustion engine, and particularly relates to an internal combustion engine including a twin entry type turbocharger.

### BACKGROUND

Conventionally, Patent Literature 1, for example, discloses an art relating to a supercharging pressure control system of an internal combustion engine equipped with a twin entry type turbocharger. An exhaust manifold of this internal combustion engine is formed to collect exhaust passages of cylinders that do not cause exhaust interference, and the respective passages are connected to two scroll passages included by the twin entry type turbocharger, respectively. Further, in a demarcation section that demarcates the two scroll passages, a scroll valve that causes these scroll passages to join each other is provided. The scroll valve is cooled by a cooling device. The cooling device transfers exhaust heat that is received by the scroll valve to a piston rod to radiate the exhaust heat to cooling water that flows in a cylinder body.

Following is a list of patent literatures which the applicant has noticed as related arts of embodiments the present disclosure.

Patent Literature 1: JP 2015-040542 A

Patent Literature 2: JP 63-117124 A

Patent Literature 3: U.S. Patent No. 2010/0083920

### SUMMARY

In the system of Patent Literature 1 described above, the scroll valve is provided to demarcate the two scroll passages, and therefore, the scroll valve is always exposed to high-temperature exhaust gas that flows in both the scroll passages. Consequently, in the configuration of the above described cooling device that radiates the heat of the scroll valve by using heat conduction, there is the fear that the valve is insufficiently cooled and a malfunction due to heat is caused.

The present disclosure is made in the light of the problem as described above, and has an object to provide an internal combustion engine capable of preventing occurrence of a malfunction of a communication control valve, in the internal combustion engine including the communication control valve that provides communication between exhaust passages that are independently connected to a twin entry type turbocharger.

In accomplishing the above object, according to a first aspect of the present disclosure, there is provided an internal combustion engine, including:

a first exhaust passage in which gas flows, which is exhausted from a first cylinder group of the internal combustion engine including a plurality of cylinders;

a second exhaust passage in which gas flows, which is exhausted from a second cylinder group configured by cylinders different from the first cylinder group;

a twin entry type turbocharger with which the first exhaust passage and the second exhaust passage respectively communicate independently;

a space forming section that forms a space that communicates with the first exhaust passage via a first communication path and communicates with the second exhaust passage via a second communication path;

a communication control valve that opens and closes the first communication path and the second communication path; and

a drive mechanism that is connected to a valve body of the communication control valve and drives the valve body to open and close the valve body,

wherein the drive mechanism is provided at a side of the space forming section with respect to the valve body in a state where the valve body is closed.

According to a second aspect of the present disclosure, there is provided the internal combustion engine according to the first aspect,

wherein a catalyst is disposed in an exhaust passage at a downstream side of the turbocharger,

the internal combustion engine further comprising: a heat exchanger that is provided inside the space forming section, and is for cooling gas in the space forming section.

According to a third aspect of the present disclosure, there is provided the internal combustion engine according to the second aspect, further including an exhaust passage demarcating section that demarcates the first exhaust passage and the second exhaust passage,

wherein the space forming section is fixed to the exhaust passage demarcating section, and

a gasket for heat insulation is interposed between the space forming section and the exhaust passage demarcating section.

According to a fourth aspect of the present disclosure, there is provided the internal combustion engine according to the second aspect, further including: an actuator that opens and closes the communication control valve by operating the drive mechanism,

wherein the actuator is fixed to the space forming section.

According to a fifth aspect of the present disclosure, there is provided the internal combustion engine according to the second aspect, further including: an actuator that opens and closes the communication control valve by operating the drive mechanism; and

a control device that controls the actuator,

wherein the heat exchanger is configured as a water cooling type heat exchanger in which cooling water flows, and

the control device operates the actuator to keep the communication control valve in a closed state when a temperature of the cooling water is a dew point of exhaust gas or less.

According to the first disclosure, the drive mechanism that drives the valve body of the communication control valve to open and close the valve body is provided at the side of the space forming section with respect to the valve body in the state where the communication control valve is closed. According to the configuration like this, the drive mechanism can be prevented from being exposed to the high-temperature exhaust gas that flows in the first exhaust passage and the second exhaust passage in the state where the communication control valve is closed. Thereby, reliability to the temperature of the drive mechanism can be effectively enhanced, and therefore, occurrence of the malfunction of the communication control valve can be prevented effectively.

According to the second disclosure, the internal combustion engine includes the cooling unit for cooling the gas in the space forming section. According to the configuration like this, in the state where the communication control valve is opened, a part of the exhaust gas that flows in the first exhaust passage or the second exhaust passage is introduced into the space forming section, and is cooled by the cooling unit. Thereby, the temperature of the exhaust gas which is introduced into the turbocharger can be reduced without depending on the fuel increasing control that increases the fuel supply amount into the cylinders, and therefore, excessive increase of the temperature of the catalyst can be restrained without reducing the engine output power.

According to the third disclosure, the space forming section is fixed to the exhaust passage demarcating section that demarcates the first exhaust passage and the second exhaust passage. At this time, the gasket for heat insulation is interposed between the space forming section and the exhaust passage demarcating section. According to the configuration like this, the heat radiation amount to the space forming section from the exhaust passage demarcating section can be restrained, and therefore, it becomes possible to restrain delay in warming-up of the catalyst.

According to the fourth disclosure, the actuator that operates the drive mechanism is fixed to the space forming section. According to the configuration like this, the actuator can be prevented from having a high temperature, and therefore reliability of the operation of the drive mechanism can be enhanced.

According to the fifth disclosure, the actuator is operated to keep the communication control valve in the closed state when the temperature of the cooling water is the dew point of the exhaust gas or less. According to the configuration like this, occurrence of exhaust gas condensed water in the heat exchanger can be restrained, and therefore corrosion of the heat exchanger can be prevented.

### BRIEF DESCRIPTION OF DRAWINGS

FIG. 1 is an exploded perspective view for explaining a configuration of an exhaust system of an internal combustion engine, which is a main part of the present disclosure;

FIG. 2 is a view for explaining a structure of an opening and closing mechanism section of a communication unit;

FIG. 3 is a view for explaining a structure of a space forming section of the communication unit;

FIG. 4 is a flowchart illustrating a routine for opening and closing a communication control valve;

FIG. 5 is a map prescribing an open and closed state of the communication control valve with respect to an operating state of the internal combustion engine;

FIG. 6 is a diagram illustrating a relation of an engine output power with respect to an air-fuel ratio;

FIG. 7 is a view for explaining a modification example of the communication unit;

FIG. 8 is an exploded view for explaining a modification example of the configuration of the communication control valve; and

FIG. 9 is an exploded view for explaining another modification example of the configuration of the communication control valve.

### DETAILED DESCRIPTION

Hereinafter, an embodiment of the present disclosure will be described with reference to the drawings. Note that when the numerals of the numbers, the quantities, the amounts, the ranges and the like of the respective elements are mentioned in the embodiment shown as follows, the present disclosure is not limited to the mentioned numerals unless specially explicitly described otherwise, or unless the disclosure is explicitly specified by the numerals theoretically. Further, the structures, steps and the like that are described in the embodiment shown as follows are not always indispensable to the present disclosure unless specially explicitly shown otherwise, or unless the disclosure is explicitly specified by the structures, steps and the like theoretically.

### First Embodiment

1. Configuration of Internal Combustion Engine of First Embodiment

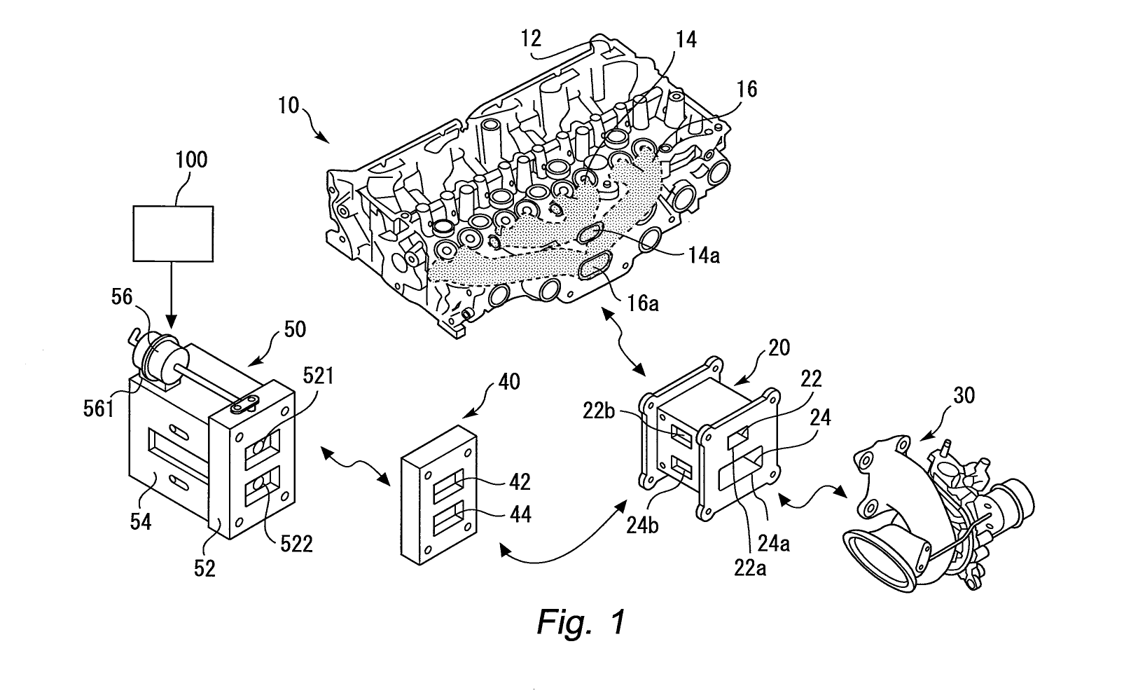

FIG. 1 is an exploded perspective view for explaining a configuration of an exhaust system of an internal combustion engine, which is a main part of the present disclosure. An internal combustion engine 10 of the present embodiment is configured as an in-line four-cylinder engine that repeats combustion in sequence of cylinder #1 to cylinder #3 to cylinder #4 to cylinder #2. Note that in FIG. 1, only a cylinder head 12 of the internal combustion engine 10 is illustrated. Inside the cylinder head 12, a first exhaust manifold 14 and a second exhaust manifold 16 are formed. That is, the first exhaust manifold 14 and the second exhaust manifold 16 are configured as cylinder head-integrated exhaust manifolds that are formed inside the cylinder head 12 of the internal combustion engine 10. The first exhaust manifold 14 is connected to cylinder #2 and cylinder #3. That is, exhaust gas that is exhausted from cylinder #2 and exhaust gas that is exhausted from cylinder #3 join each other in the first exhaust manifold 14, and are exhausted from an outlet port 14a. Hereinafter, a cylinder group that is configured by cylinder #2 and cylinder #3 will be referred to as “a first cylinder group”.

Meanwhile, the second exhaust manifold 16 is connected to cylinder #1 and cylinder #4. That is, exhaust gas that is exhausted from cylinder #1, and exhaust gas that is exhausted from cylinder #4 join each other in the second exhaust manifold 16, and are exhausted from an outlet port 16a. Hereinafter, a cylinder group that is configured by cylinder #1 and cylinder #4 will be referred to as “a second cylinder group”.

The internal combustion engine 10 is equipped with an exhaust passage section 20. Inside the exhaust passage section 20, a first passage 22 and a second passage 24 are formed in parallel. The exhaust passage section 20 is fixed to the cylinder head 12, whereby the outlet port 14a of the first exhaust manifold 14 is connected to an inlet port of the first passage 22, and the outlet port 16a of the second exhaust manifold 16 is connected to an inlet port of the second passage 24, respectively.

The internal combustion engine 10 is equipped with a turbocharger 30. The turbocharger 30 has a turbine that is operated by energy of the exhaust gas of the internal combustion engine 10, and a compressor that is driven by the turbine. An inlet passage not illustrated is connected to the compressor. Intake air can be compressed by the compressor.

The turbine has two inlet ports. That is, the turbocharger 30 is configured as a twin entry type turbocharger. An outlet port 22a of the first passage 22 is connected to one of the inlet ports of the turbine, and an outlet port 24a of the second passage 24 is connected to the other inlet port. The first exhaust manifold 14, the first passage 22, the second exhaust manifold 16 and the second passage 24 correspond to an exhaust passage demarcating section that demarcates an exhaust passage from respective cylinders of the internal combustion engine 10 to the turbocharger 30. In the following explanation, an exhaust passage that is demarcated by the first exhaust manifold 14 and the first passage 22 will be referred to as “a first exhaust passage”, and an exhaust passage that is demarcated by the second exhaust manifold 16 and the second passage 24 will be referred to as “a second exhaust passage”. An exhaust passage not illustrated is connected to an outlet port of the turbine. A catalyst or the like that purifies exhaust gas is installed midway in the exhaust passage. According to the twin entry type turbocharger 30 like this, interference of exhaust pulsations among cylinders can be restrained, and excellent supercharging characteristics can be obtained.

Further, in the exhaust passage section 20, a first communication path 22b and a second communication path 24b that respectively open to outside from the first passage 22 and the second passage 24 are formed. A communication unit 50 is connected to the first communication path 22b and the second communication path 24b of the exhaust passage section 20 via a gasket 40. The gasket 40 is formed of a member having a heat insulating function, and in portions corresponding to the first communication path 22b and the second communication path 24b, a first opening 42 and a second opening 44 are formed.

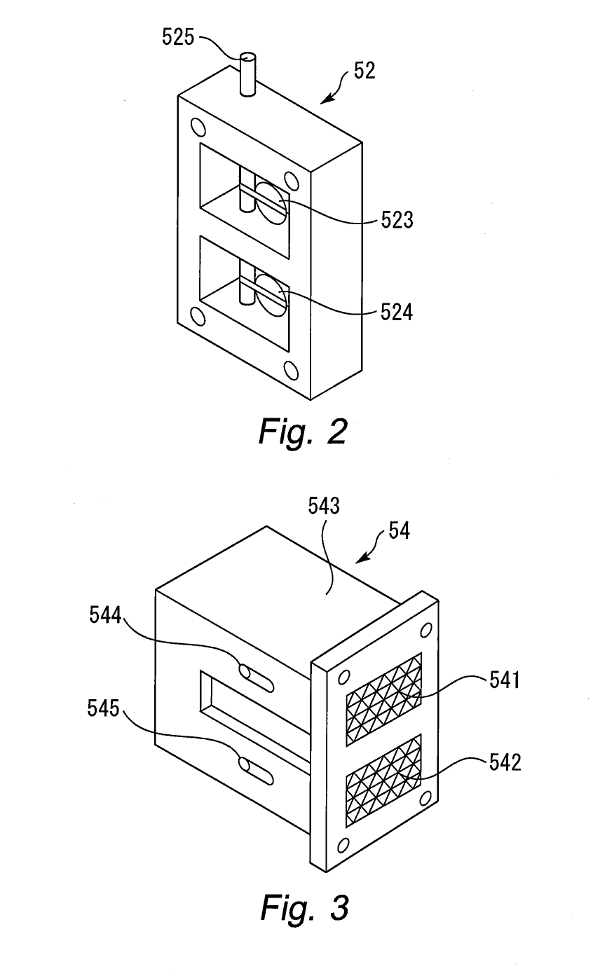

The communication unit 50 is configured by an opening and closing mechanism section 52, a space forming section 54 and an actuator 56. FIG. 2 is a view for explaining a structure of the opening and closing mechanism section 52 of the communication unit 50. Further, FIG. 3 is a view for explaining a structure of the space forming section 54 of the communication unit 50. Hereinafter, a configuration of the communication unit 50 will be described in more detail with reference to FIG. 2 and FIG. 3 in addition. In the opening and closing mechanism section 52, a first opening 521 that communicates with the first communication path 22b and a second opening 522 that communicates with the second communication path 24b in a state where the communication unit 50 is fixed to the exhaust passage section 20 are formed. The opening and closing mechanism section 52 includes a first communication control valve 523 including a valve body for opening and closing the first opening 521, and a second communication control valve 524 that includes a valve body for opening and closing the second opening 522. The first communication control valve 523 and the second communication control valve 524 are disposed to open and close the respective openings from a side of the space forming section 54. Further, the opening and closing mechanism section 52 includes a shaft 525 as a drive mechanism for opening and closing the valve bodies of the first communication control valve 523 and the second communication control valve 524. The shaft 525 is disposed rotatably to be exposed to a space at the side of the space forming section 54 with respect to the valve bodies in a state where the first communication control valve 523 and the second communication control valve 524 are closed. The valve bodies of the first communication control valve 523 and the second communication control valve 524 are respectively fixed to the shaft 525, and are configured to open and close in response to rotation of the shaft 525. The shaft 525 is driven by the actuator 56. The actuator 56 is configured as a diaphragm type actuator that is driven by a negative pressure, for example, and is fixed to the space forming section 54 by a bracket 561. The actuator is controlled by a control device 100.

In the space forming section 54, a first passage 541 that communicates with the first communication path 22b and a second passage 542 that communicates with the second communication path 24b in a state where the communication unit 50 is fixed to the exhaust passage section 20 are formed. The first passage 541 and the second passage 542 communicate with each other inside the space forming section 54. Further, inside the first passage 541 and the second passage 542, a heat exchanger 543 for cooling the exhaust gas is disposed. The heat exchanger 543 is a water-cooling type heat exchanger that performs heat exchange between cooling water and exhaust gas, and is provided with a cooling water introduction port 544, and a cooling water lead-out port 545.
2. Feature of System of First Embodiment
2-1. Opening and Closing Control of Communication Control Valve

As described above, according to a twin entry type turbocharger, interference of exhaust pulsations among the cylinders can be restrained, and therefore, excellent supercharging characteristics can be obtained. However, a twin entry type turbocharger has the problem that exhaust resistance is high and output power is restricted in a high load region due to the structure, although the twin entry type turbocharger is suitable to increase full load torque in a low engine speed region of an internal combustion engine. Meanwhile, an ordinary single entry type turbocharger cannot take out sufficient exhaust energy in the low engine speed region, and therefore, cannot obtain output performance in the low engine speed region.

Thus, the twin entry type turbocharger 30 in the system of the present embodiment includes the first communication control valve 523 and the second communication control valve 524 to causes the first exhaust passage and the second exhaust passage to communicate with each other. Opening and closing of the first communication control valve 523 and the second communication control valve 524 are controlled in accordance with the operating state of the internal combustion engine 10. More specifically, in the system of the present embodiment, the first communication control valve 523 and the second communication control valve 524 are closed to cut off communication of the first exhaust passage and the second exhaust passage in the low engine speed region of the internal combustion engine 10. Thereby, the turbocharger 30 functions as a twin entry type turbocharger. Meanwhile, in a high engine speed and high load region of the internal combustion engine 10, the first communication control valve 523 and the second communication control valve 524 are opened to provide communication of the first exhaust passage and the second exhaust passage. Thereby, the turbocharger 30 functions as an ordinary single entry type turbocharger. In this way, according to the twin entry type turbocharger 30 including the first communication control valve 523 and the second communication control valve 524, high output performance can be obtained irrespective of the operating state of the internal combustion engine 10.

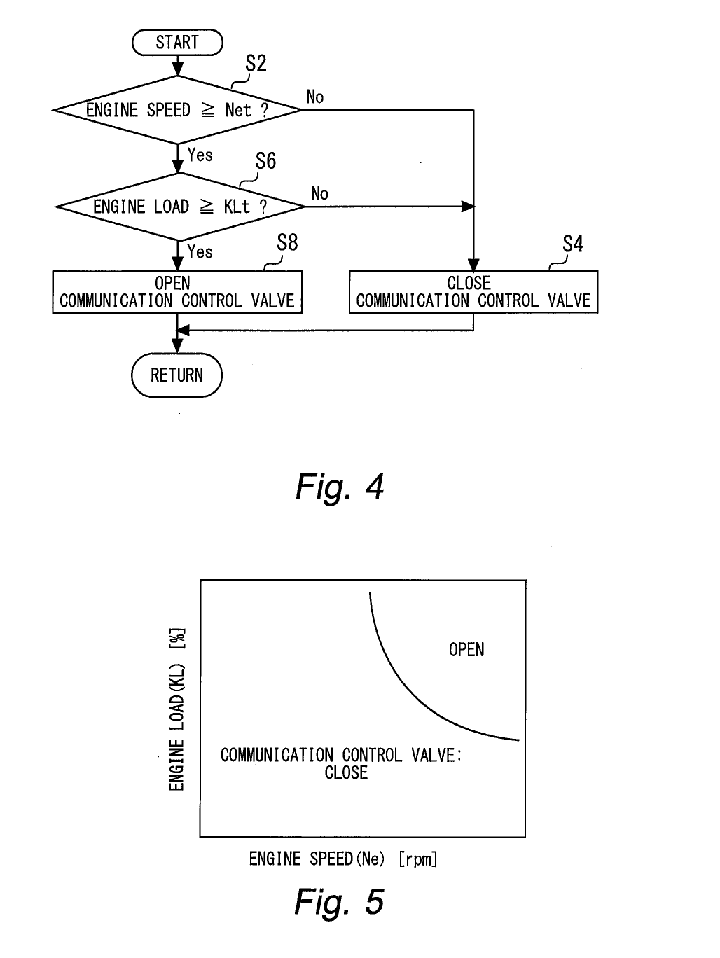

Next, specific processing for the system of the present embodiment to open and close the communication control valves will be described. FIG. 4 is a flowchart illustrating a routine for performing opening and closing of the communication control valve. The routine illustrated in FIG. 4 is repeatedly executed at each predetermined control period. In the routine illustrated in FIG. 4, it is determined whether or not the present engine speed is Net or more (step S2). Net represents a maximum value of the engine speed at which the first communication control valve 523 and the second communication control valve 524 should be closed irrespective of the engine load, and a value that is set in advance is used. When establishment of the engine speed≧Net is not recognized as a result, the present operating state of the internal combustion engine 10 is determined as an operating state in which the first communication control valve 523 and the second communication control valve 524 should be closed irrespective of the engine load. In this case, the flow shifts to the next step, the first communication control valve 523 and the second communication control valve 524 are closed (step S4), and the present routine is ended.

When establishment of the engine speed≧Net is recognized in step S2 described above, the present operating state is determined to have a possibility of being the operating state in which the first communication control valve 523 and the second communication control valve 524 should be opened, and the flow shifts to the next step. In the next step, it is determined whether or not the engine load is KLt or more (step S6). FIG. 5 is a map specifying the opening and closing state of the communication control valve with respect to the operating state of the internal combustion engine. KLt is set at a minimum value of the engine load under which the communication control valve should be opened in the present engine speed, in the map illustrated in FIG. 5. When establishment of the engine load≧KLt is not established as a result, the flow shifts to step S4 described above, the first communication control valve 523 and the second communication control valve 524 are closed, and the present routine is ended. Meanwhile, when establishment of the engine load≧KLt is recognized in step S6 described above, the present operating state of the internal combustion engine can be determined as the operating state in which the communication control valve should be opened. In this case, the flow shifts to the next step, the first communication control valve 523 and the second communication control valve 524 are opened (step S8), and the present routine is ended. In this way, according to the system of the present embodiment, it becomes possible to control opening and closing of the communication control valves in accordance with the operating state of the internal combustion engine 10.

Note that the opening and closing control of the first communication control valve 523 and the second communication control valve 524 is not limited to a method of the above described routine. That is, in the opening and closing control of the first communication control valve 523 and the second communication control valve 524, opening and closing of the communication control valves may be controlled in accordance with whether the operating state that is set based on the engine speed and the engine load belongs to the opening region or the closing region of the communication control valve in the map illustrated in FIG. 5.
2-2. Feature of Communication Unit 50
2-2-1. Feature of Opening and Closing Mechanism Section

According to the aforementioned configuration of the opening and closing mechanism section 52, the shaft 525 is disposed to be exposed to the space at the side of the space forming section 54 with respect to the valve body in the state where the first communication control valve 523 and the second communication control valve 524 are closed. When the first communication control valve 523 and the second communication control valve 524 are closed, the space forming section 54 is isolated from the high-temperature exhaust gas that flows in the first exhaust passage and the second exhaust passage. Consequently, in the state where the first communication control valve 523 and the second communication control valve 524 are closed, the shaft 525 can be prevented from being exposed to the high-temperature exhaust gas, and therefore, occurrence of a malfunction of the shaft 525 due to heat can be effectively prevented.
2-2-2. Feature of Space Forming Section

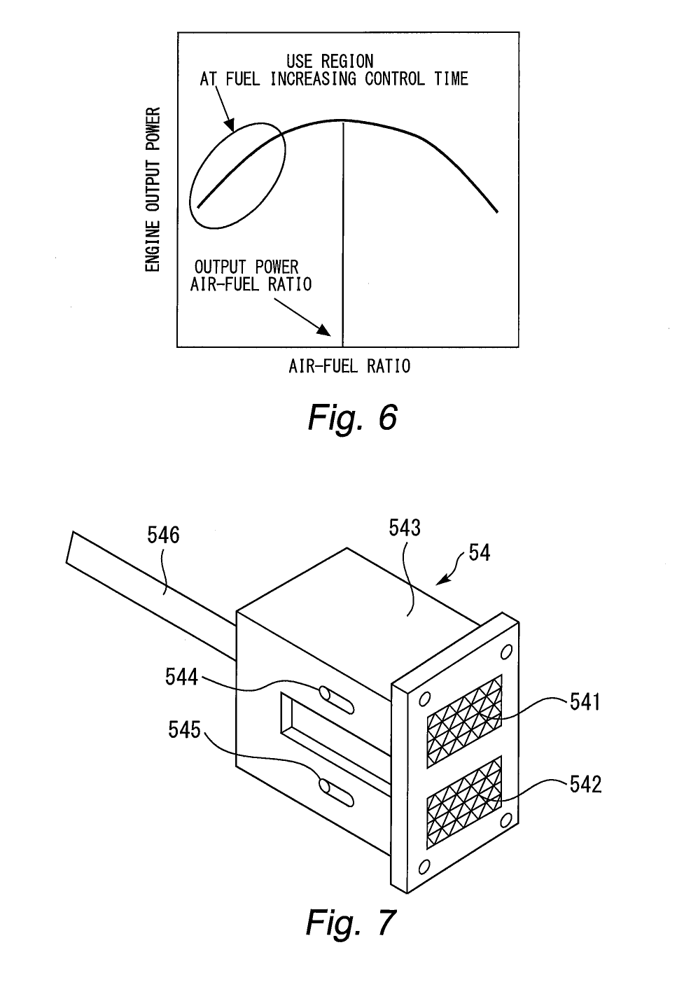

FIG. 6 is a diagram illustrating a relation of engine output power to an air-fuel ratio. In order to prevent the temperature of the exhaust gas flowing into the catalyst from being excessively high, fuel increasing control of increasing fuel to be supplied into the cylinders is sometimes performed in a predetermined high engine speed and high load region. However, as illustrated in FIG. 6, when the air-fuel ratio shifts to a fuel rich side by the fuel increasing control, the engine output power is reduced.

According to the configuration of the communication unit 50 in the system of the present embodiment, the heat exchanger 543 for cooling the exhaust gas is disposed inside the first passage 541 and the second passage 542. According to the configuration like this, the exhaust gas that flows in the first exhaust passage and the second exhaust passage is cooled by the communication unit 50, in the high engine speed and high load region in which the first communication control valve 523 and the second communication control valve 524 are opened. Thereby, the temperature of the exhaust gas that flows into the catalyst can be reduced, and therefore, it becomes possible to restrain reduction in the engine output power by reducing a change of carrying out the fuel increasing control, and restrain worsening of fuel efficiency.

Further, engine cooling water that flows in a main body of the internal combustion engine 10 is configured to be introduced into the heat exchanger 543. The engine cooling water is normally regulated to be a temperature of approximately 80° C., and therefore is higher than a dew point (approximately 40° C., for example) of the exhaust gas. However, at a time of a cold start of the internal combustion engine 10 or the like, the temperature of the engine cooling water does not sometimes reach the dew point of the exhaust gas. Thus, in the system of the present embodiment, in the case where the temperature of the engine cooling water is the dew point of the exhaust gas or less, the actuator is operated by the control device 100 such that the first communication control valve 523 and the second communication control valve 524 are kept in a closed state. Thereby, it becomes possible to prevent dew condensation in the heat exchanger 543 to restrain occurrence of corrosion.
2-2-3. Feature of Gasket

In the system of the present embodiment, the first communication path 22b and the second communication path 24b of the exhaust passage section 20 are connected to the communication unit 50 via the gasket 40. Since the gasket 40 is formed from a material having a heat insulation property as described above, heat transfer to the communication unit 50 from the first communication path 22b and the second communication path 24b can be effectively prevented.
2-2-4. Feature of Actuator

Since the gasket 40 is provided between the exhaust passage section 20 and the communication unit 50 as described above, heat transfer to the space forming section 54 from the exhaust passage section 20 is restrained. Further, the space forming section 54 contains the heat exchanger 543, and therefore, a surface and surroundings of the space forming section 54 have a lower temperature as compared with the other components of the exhaust system. Since the actuator 56 of the present embodiment is fixed to the space forming section 54 by the bracket 561, a temperature of the actuator 56 can be restrained from being increased to a high temperature. Thereby, occurrence of a malfunction of the actuator 56 can be effectively prevented.
3. Modification Examples

The present disclosure is not limited to the aforementioned embodiment, and can be carried out by being variously modified within the range without departing from the gist of the present disclosure. For example, modification examples as follows may be adopted.

The communication unit 50 of the system of the first embodiment may also function as a takeout port for exhaust gas (EGR gas) that is recirculated to the intake system. FIG. 7 is a view for explaining a modification example of the communication unit. As illustrated in FIG. 7, the communication unit 50 is provided with an EGR passage 546 that communicates with an inside of the space forming section 54. According to the configuration like this, the exhaust gas that is cooled in the heat exchanger 543 can be taken out from the EGR passage 546, and therefore, the low-temperature exhaust gas can be recirculated to the intake system without additionally providing an EGR cooler.

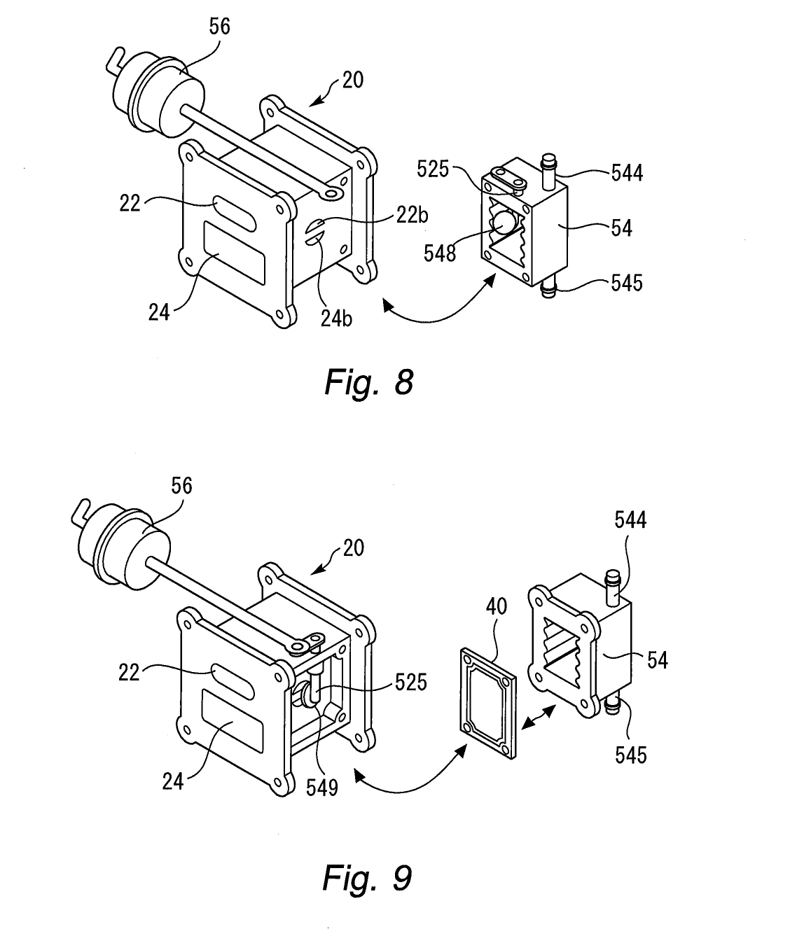

In the system of the first embodiment described above, the first communication path 22b and the second communication path 24b are respectively opened and closed by the first communication control valve 523 and the second communication control valve 524. However, the configuration of the communication control valve is not limited to this, and such a configuration may be adopted, that opens and closes both the first communication path 22b and the second communication path 24b by a single communication control valve, for example. FIG. 8 is an exploded view for explaining a modification example of the configuration of the communication control valve. In an example illustrated in FIG. 8, a single communication control valve 548 is provided in the opening and closing mechanism section 52. The communication control valve 548 is configured to close both the first communication path 22b and the second communication path 24b which are formed in the exhaust passage section in the valve closed state. According to the configuration like this, it becomes possible to switch communication and cutoff of the first communication path 22b and the second communication path 24b by rotating the shaft 525 by the actuator 56.

Further, FIG. 9 is an exploded view for explaining another modification example of the configuration of the communication control valve. In the example illustrated in FIG. 9, a single communication control valve 549 and the shaft 525 as a drive mechanism are provided at the side of the exhaust passage section 20. Further, the communication control valve 549 is configured to close both the first communication path 22b and the second communication path 24b which are formed in the exhaust passage section, in the valve closed state. By the configuration like this, it also becomes possible to switch communication and cutoff of the first communication path 22b and the second communication path 24b by rotating the shaft 525 by the actuator 56.

Further, in the system of the first embodiment described above, the configuration in which the heat exchanger 543 is provided inside the space forming section 54 in the communication unit 50 is described, but the configuration of the heat exchanger 543 is not indispensable.

What is claimed is:

1. An internal combustion engine, comprising:
a first exhaust passage in which gas flows, which is exhausted from a first cylinder group of the internal combustion engine including a plurality of cylinders;
a second exhaust passage in which gas flows, which is exhausted from a second cylinder group configured by cylinders different from the first cylinder group;
a twin entry type turbocharger with which the first exhaust passage and the second exhaust passage respectively communicate independently;
a space forming section that forms a space that communicates with the first exhaust passage via a first communication path and communicates with the second exhaust passage via a second communication path;
a communication control valve that opens and closes the first communication path and the second communication path; and
a drive mechanism that is connected to a valve body of the communication control valve and drives the valve body to open and close the valve body,
wherein the drive mechanism is provided at a side of the space forming section with respect to the valve body in a state where the valve body is closed.

2. The internal combustion engine according to claim 1,
wherein a catalyst is disposed in an exhaust passage at a downstream side of the turbocharger,
the internal combustion engine further comprising: a heat exchanger that is provided inside the space forming section, and is for cooling gas in the space forming section.

3. The internal combustion engine according to claim 2, further comprising an exhaust passage demarcating section that demarcates the first exhaust passage and the second exhaust passage,
wherein the space forming section is fixed to the exhaust passage demarcating section, and
a gasket for heat insulation is interposed between the space forming section and the exhaust passage demarcating section.

4. The internal combustion engine according to claim 2, further comprising: an actuator that opens and closes the communication control valve by operating the drive mechanism,
wherein the actuator is fixed to the space forming section.

5. The internal combustion engine according to claim 2, further comprising:
an actuator that opens and closes the communication control valve by operating the drive mechanism; and
a control device that controls the actuator,
wherein the heat exchanger is configured as a water cooling type heat exchanger in which cooling water flows, and
the control device operates the actuator to keep the communication control valve in a closed state when a temperature of the cooling water is a dew point of exhaust gas or less.
